(19) United States
(12) Patent Application Publication
(10) Pub. No.: US 2024/0330034 A1
(43) Pub. Date: Oct. 3, 2024

(54) METHOD AND DEVICE FOR IMPLEMENTING VIRTUAL MACHINE INTROSPECTION

(71) Applicant: SAMSUNG ELECTRONICS CO., LTD., SUWON-SI (KR)

(72) Inventors: MINDONG ZHAO, SHAANXI (CN); DONG KOU, SHAANXI (CN); TIANJIE ZHAO, SHAANXI (CN)

(21) Appl. No.: 18/399,831

(22) Filed: Dec. 29, 2023

(30) Foreign Application Priority Data
Mar. 30, 2023 (CN) 202310332256.1

(51) Int. Cl. G06F 9/455

(52) U.S. Cl. CPC G06F 9/45558; G06F 2009/45562

(57) ABSTRACT

A method for implementing a virtual machine introspection includes: receiving a read request to access a memory area of a virtual machine through a Hypervisor for data reading; the Hypervisor accessing the memory area of the virtual machine to perform an operation of reading data according to the read request to return an operation result; and reconstructing semantic information based on the operation result, on an apparatus located outside a virtualization system that includes the Hypervisor.

### CROSS-REFERENCE TO RELATED APPLICATIONS

This U.S. patent application claims priority under 35 U.S.C. § 119 to Chinese Patent Application No. 202310332256.1, filed on Mar. 30, 2023, in the Chinese Intellectual Patent Office, the disclosure of which is incorporated by reference in its entirety herein.

### TECHNICAL FIELD

The present disclosure relates to the field of data security, and more particularly relates to a method and a device for implementing virtual machine introspection.

### DISCUSSION OF RELATED ART

In computing, a Virtual Machine (VM) is the virtualization or emulation of a computer system. VMs are based on computer architectures and provide the functionality of a physical computer. A Hypervisor may be a type of computer software that executes the VM.

Virtual Machine Introspection (VMI) technology monitors a running state of a VM at a Hypervisor level. This technology can detect and prevent abnormal intrusion by analyzing activities of an operating system of the VM at runtime.

Because the VMI can monitor and analyze the state of the VM at runtime, it can be used to increase product maintainability. For example, when the VM is abnormal and tasks cannot run normally, current state information inside the VM can be obtained by the VMI technology for further analysis. The mechanism of the Hypervisor can also be optimized using information obtained from the VM. Because the Hypervisor has permission to access hardware resources of the VM, the Hypervisor has a complete view of the resources accessed by the operating system running on the VM.

However, from the perspective of the Hypervisor, the data obtained from the VM are only original bits or byte data, which lack higher level operating system abstraction or semantic information. This problem is also known as the Semantic Gap. Therefore, VMI technology needs to overcome the Semantic Gap and reconstruct abstraction of data structure and high-level semantic information of the operating system of the VM.

### SUMMARY

According to an embodiment of the present disclosure, a method of implementing virtual machine introspection (VMI) is provided. The method includes: receiving a read request to access a memory area of a virtual machine through a Hypervisor for reading read data; the Hypervisor accessing the memory area of the virtual machine to perform an operation of reading the data according to the read request to return an operation result; and reconstructing semantic information based on the operation result, on an apparatus located outside a virtualization system that includes the Hypervisor.

The reconstructing of the semantic information may include: parsing metadata included in the operation result by using symbol table information and source code of an operating system of the virtual machine; and reconstructing data structure and high-level semantic information of the operating system of the virtual machine according to the parsed metadata.

After the semantic information is reconstructed, the method may further include: receiving a write request to access the memory area of the virtual machine through the Hypervisor for writing write data, and the Hypervisor accessing the memory area of the virtual machine to perform an operation of writing the write data according to the write request; and receiving a program scheduling request for scheduling a virtual machine program in the operating system of the virtual machine in the Hypervisor, and the Hypervisor scheduling the virtual machine program to perform operations according to the program scheduling request, wherein, the write request and the program scheduling request conform to data structure and high-level semantic information of the operating system of the virtual machine obtained through the reconstructing semantic information.

In an embodiment, each of the read request, the write request and the program scheduling request is received from the apparatus, and at least includes a virtual machine ID, an operation type, and a virtual address of a symbol.

In an embodiment, the operation of reading the read data includes: determining a corresponding virtual machine, according to the virtual machine ID included in the read request request; determining the memory area of the virtual machine to be accessed, according to the determined virtual machine and the virtual address of the symbol included in the read request; and performing a read operation on the memory area of the virtual machine.

In an embodiment, the operation of writing the write data includes: determining a corresponding virtual machine, according to the virtual machine ID included in the write request; determining the memory area of the virtual machine to be accessed, according to the determined virtual machine and the virtual address of the symbol included in the write request; and performing a write operation on the memory area of the virtual machine.

The scheduling of the virtual machine program to perform the operation may be executed in the Hypervisor at an exception level 2 to support Virtualization Host Extension Features.

In an embodiment, the scheduling of the virtual machine program to perform the operation includes: determining a corresponding virtual machine, according to the virtual machine ID included in the program scheduling request; determining the virtual machine program in the operating system of the virtual machine, according to the determined virtual machine and the virtual address of the symbol included in the program scheduling request; and scheduling the virtual machine program to perform an operation, in the Hypervisor.

According to an embodiment of the present disclosure, a device of implementing virtual machine introspection (VMI) is provided. The device includes: a VMI message processing module configured to receive a read request to access a memory area of a virtual machine through a Hypervisor for reading read data; a data detection module configured to access the memory area of the virtual machine to perform an operation of reading the read data according to the read request in the Hypervisor to return an operation result; and a semantic information reconstructing module configured to reconstruct semantic information based on the operation result, on an apparatus located outside a virtualization system that includes the Hypervisor.

In an embodiment, the semantic information reconstructing module reconstructs the semantic information by: parsing metadata contained in the operation result by using symbol table information and source code of an operating system of the virtual machine; and reconstructing data structure and high-level semantic information of the operating system of the virtual machine according to the parsed metadata.

In an embodiment, the VMI message processing module is further configured to receive a write request to access the memory area of the virtual machine through the Hypervisor for writing write data, and the data detection module is further configured to access the memory area of the virtual machine to perform an operation of writing the write data according to the write request in the Hypervisor.

In an embodiment, the VMI message processing module is further configured to receive a program scheduling request for scheduling a virtual machine program in the operating system of the virtual machine in the Hypervisor.

In an embodiment, the device further includes: an Operating System (OS) routine execution module configured to schedule the virtual machine program to perform operations according to the program scheduling request in the Hypervisor, wherein, the write request and the program scheduling request conform to data structure and high-level semantic information of the operating system of the virtual machine obtained through the reconstructed semantic information.

In an embodiment, each of the read request, the write request and the program scheduling request is received from the apparatus, and at least includes a virtual machine ID, an operation type, and a virtual address of a symbol.

In an embodiment, the data detection module performs the operation of reading the read data by: determining a corresponding virtual machine, according to the virtual machine ID included in the read request; determining the memory area of the virtual machine to be accessed, according to the determined virtual machine and the virtual address of the symbol included in the read request; and performing a read operation on the memory area of the virtual machine.

In an embodiment, the data detection module performs the operation of writing of the write data by: determining a corresponding virtual machine, according to the virtual machine ID included in the write request; determining the memory area of the virtual machine to be accessed, according to the determined virtual machine and the virtual address of the symbol included in the write request; and performing a read operation on the memory area of the virtual machine.

In an embodiment, the OS routine execution module schedules the virtual machine program to perform operations in the Hypervisor at an exception level 2 to support Virtualization Host Extension Features.

In an embodiment, the OS routine execution module schedules the virtual machine program to perform operations by: determining a corresponding virtual machine, according to the virtual machine ID included in the program scheduling request; determining the virtual machine program in the operating system of the virtual machine, according to the determined virtual machine and the virtual address of the symbol included in the program scheduling request; and scheduling the virtual machine program to perform operations, in the Hypervisor.

According to an exemplary embodiment, a computer program product is provided for implementing virtual machine introspection (VMI). The computer program product is tangibly embodied on a non-transitory computer-readable storage medium and includes instructions that, when executed by at least one computing device, are configured to cause the at least one computing device to: receive a read request from a Hypervisor to access a memory area of a virtual machine for reading read data; access the memory area of the virtual machine using the Hypevisor to perform an operation for reading the read data according to the read request to return an operation result; and reconstruct semantic information by an apparatus based on the operation result, where the apparatus is located outside a virtualization system including the Hypervisor.

At least one embodiment of the disclosure does not need to make any modification or addition of any module in the operating system of the virtual machine, and completely eliminate the performance overhead of the operating system of the virtual machine caused by adding new modules.

At least one embodiment of the disclosure monitors a running state of the virtual machine by adding only lightweight modules (for example, a VMI message processing module, a data detection and routine execution module (that is, a data detection module and a OS routine execution module) into the Hypervisor.

At least one embodiment of the disclosure can access and modify running parameters of the operating system of the virtual machine on the Hypervisor side (such as executing the running parameters through write operations and scheduling the tasks), so as to optimize the running strategy of the operating system.

In a virtualization system according to an embodiment of the disclosure with hardware supporting Virtualization Host Extension Features (VHE), by running a specified virtual machine program on the Hypervisor side, the timing and order of the execution of the client virtual machine functions (such as an initialization function in the startup phase of the operating system of the virtual machine) may be changed, so as to increase the operation efficiency of the system.

At least one embodiment of the disclosure can perform semantic reconstruction through a semantic information reconstructing module set in the PC end outside the virtualization system, which can greatly reduces the burden on the Hypervisor, and similarly, reduces the performance overhead on the entire system.

It should be understood that the above summary and the below detailed description are only exemplary and explanatory, and do not limit the present disclosure.

### BRIEF DESCRIPTION OF THE DRAWINGS

A detailed description of each drawing is provided to facilitate a more thorough understanding of the drawings referenced in the detailed description of the present disclosure.

FIG. 1 is a diagram illustrating different types of virtualization systems;

FIG. 2 is an exemplary framework according to an exemplary embodiment of the present disclosure;

FIG. 3 is a flowchart illustrating a method of implementing VMI according to an exemplary embodiment of the present disclosure;

FIG. 4 is a block diagram illustrating a device for implementing VMI according to an exemplary embodiment of the present disclosure; and

FIG. 5 is a block diagram illustrating an electronic apparatus according to an exemplary embodiment of the present disclosure.

### DETAILED DESCRIPTION OF THE EMBODIMENTS

Hereinafter, embodiments of the present disclosure are described to such an extent that one of ordinary skill in the art may implement the present disclosure.

As discussed above, VMI technology faces the problem of semantic gap.

A first method adds a hook function to a system call of interest in the operating system of the VM. In this case, when the system call to which the hook function is added is executed, the hook function explicitly sends the running activities of the VM to a Hypervisor through a Hypercall, so that the Hypervisor can monitor the activities of interest.

However, because this first method needs to add the hook function and a related HyperCall to the operating system of the VM, it reduces system performance and increases the possibility of malware attacks.

A second method is based on a trap exception. In a hardware supported virtualization system, the second method will trigger a trap event actively or passively. When a VM accesses sensitive resources, or states and events generated by hardware resources, it will trigger a trap event, such as VM switching, interrupts and exceptions. When the Hypervisor receives and processes the trap event, it can obtain context information while operating the VM to monitor the VM.

However, the second method is limited to observing specified events, and many system calls and memory accesses will not automatically fall into the Hypervisor. Therefore, the context information obtained by this method is mainly limited to information in the processor register and it is difficult to obtain main data structures in the operating system.

A third method is based on operating system source code analysis. The third method mainly uses the publicly published operating system information to solve the problem of the semantic gap. For example, it may use symbol table information of a guest operating system to locate data in a corresponding memory area, and then analyze the located data. In this way, it can locate data structure information in a specific virtual operating system, so as to achieve an effect of monitoring the VM.

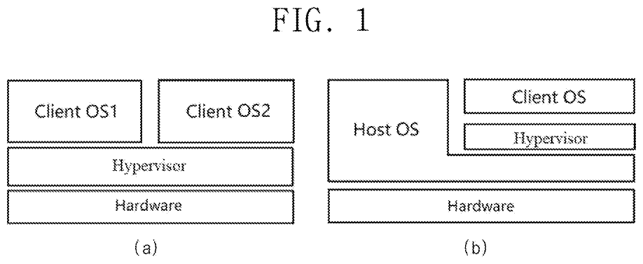

As shown in the (b) of FIG. 1, the third method is mainly used in a host client (Type-2) virtualization system, which uses the inherent advantages of the host operating system (HostOS) to directly access the memory and other information of the client VM (GuestVM). However, this method is not applicable to the bare metal (Type-1) virtualization system shown in (a) of FIG. 1.

Therefore, the present disclosure proposes a method of implementing VMI for Type-1 virtualization system. The method can realize VMI by modifying the Hypervisor without any modification to the client operating system (such as adding an agent module or hook function). The method can, on an apparatus outside the virtualization system, read metadata from the memory area of the virtual machine through the Hypervisor and parse the metadata to reconstruct the abstraction of the high-level semantic information of the operating system of the VM and data structure of the operating system, which not only reduces the burden on the Hypervisor side, but also greatly reduces the impact on the performance of the entire virtual machine system. In addition, after the semantic information is reconstructed, the Hypervisor can access the memory area of the VM to write data according to a received write request, thereby optimizing the operation strategy of the operating system, and can schedule the virtual machine programs in the operating system of the virtual machine according to a received program scheduling request through the Hypervisor, thereby changing the timing and order of the execution of the client virtual machine functions, so as to increase the operation efficiency of the system.

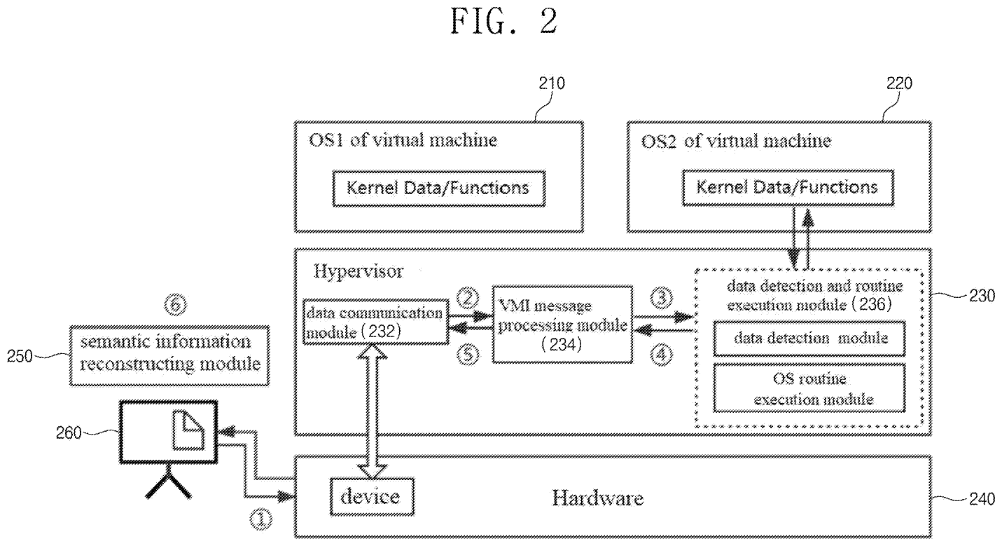

FIG. 2 is an exemplary framework of a virtualization system according to an exemplary embodiment of the present disclosure.

As shown in FIG. 2, the virtualization system includes an operating system (OS) (e.g., a first operating system 210, a second operating system 220, etc.) of a VM, a Hypervisor 230, and Hardware 240. Each operating system may include kernal data and executable functions. At least one embodiment of the disclosure does not require a change to the operating system of the VM. In other words, embodiments of the disclosure are concentrated entirely in the Hypervisor in the virtualization system, or in both the Hypervisor in the virtualization system and an external apparatus 260 outside the virtualization system. For example, the external apparatus may be a personal computer (PC). In an embodiment, the Hypervisor 230 includes a data communication module 232, a VMI message processing module 234, and a data detection and routine execution module 236. The data detection and routine execution module 236 may include a data detection module 237 and an OS routine execution module 238. The virtualization system may further include a semantic information reconstructing module 250.

The semantic information reconstructing module 250 may be deployed on the PC side, but embodiments of the present disclosure are not limited therto. For example, module 250 can instead be deployed on the Hypervisor 230. However, in order to reduce the burden on the Hypervisor, module 250 may be deployed on the PC side. Module 250 can be used as an interface to enable users to interact with the virtualization system. Module 250 can send information about a VM that a user needs to monitor or information about a VM program that a user need to execute to the VMI message processing module 234 in the Hypervisor 230 as user request messages, and at the same time, module 250 can receive the result data output by the VMI message processing module 234, reconstruct semantic information of metadata in the result data, and feed back results to the user.

After receiving a user request message transmitted from the semantic information reconstructing module 250 to the Hypervisor 230, module 234 parses the user request message to generate a parsing result and transmits the parsing result to the data detection and routine execution module 236. In addition, module 234 can encapsulate the results fed back from the data detection and routine execution module 236 and transmit the encapsulation results to the semantic information reconstructing module 250.

As shown in FIG. 2, the data detection and routine execution module 236 includes a data detection module 237 and a OS routine execution module 238.

When it is determined that the type of operation the user wants to perform is a read/write operation according to the parsing result received from the VMI message processing module 234, the data detection module 237 accesses system resources of the VM (such as the memory area of the VM) in the Hypervisor 230 according to the parsing result to perform data read/write operations, and returns the processing results to the VMI message processing module 234.

When it is determined according to the parsing result that the type of operation the user wants to operate is scheduling a virtual machine program in the operating system of the VM, the OS routine execution module 238 schedules the virtual machine program in the Hypervisor 230, and returns the processing result to the VMI message processing module 234. Specifically, when the OS routine execution module 238 implements the above processing, it needs verify that the Hardware 240 of the current virtualization system can support virtualization host extension (VHE). In this case, according to the parsing result, in an Exception Level 2 (EL2), the virtual machine program in the operating system of the VM specified by the user is scheduled in the Hypervisor 230 to control a policy or running state of the operating system of the VM, and the processing results are returned.

It should be noted that in the example shown in FIG. 2, the Hypervisor 230 also includes a data communication module 232, which is used to realize the interaction between the Hypervisor 230 and hardware resources of the Hardware 240. For example, the user request message received from the external PC end 260 through the hardware resources can be transmitted to the VMI message processing module 234, and the encapsulation result output by the VMI message processing module 234 can be transmitted to the PC end 260 through the hardware resources. In alternate embodiment, the data communication module 232 is an exising module of the Hypervisor 230, and accordingly does not need to be added. In addition, the modification of the Hypervisor 230 is not limited to the above examples, that is, the above modules can be merged or combined, as long as the method of implementing VM introspection described below can be executed.

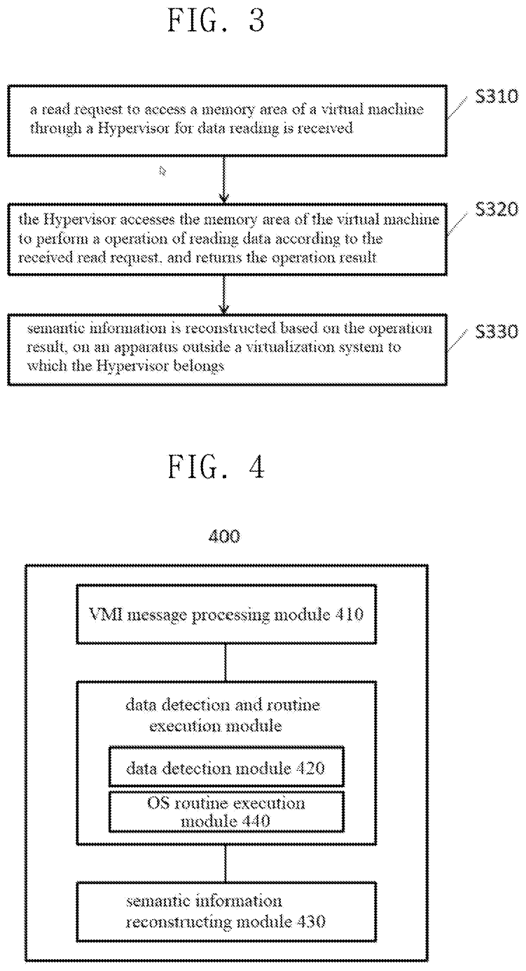

FIG. 3 is a flowchart illustrating a method of implementing VMI according to an exemplary embodiment of the present disclosure.

At step S310, a read request to access a memory area of a virtual machine through a Hypervisor for data reading is received. For example, the Hypervisor 230 may receive a read request to access a memory area of a VM for reading data from the memory area.

A virtual address corresponding to each symbol may be obtained using kernel symbol table information of an operating system of the VM. The symbol may represent a function name or variable name. Then, according to the demand, the user inputs the read request to access the memory area of the VM through the Hypervisor 230 for reading data. The read request can be received from an external apparatus 260. Then, the semantic information reconstructing module 250 in FIG. 2 transmits the read request to the VMI message processing module 234 in the Hypervisor 230. In an embodiment, the read request includes at least a virtual machine identifier (ID), an operation type and a virtual address of the symbol. For the read request, the operation type can indicate the read operation type. In an embodiment, the virtual machine ID represents an identification number of a virtual machine installed on the virtualization system (such as the Type-1 virtualization system shown in (a) of FIG. 1). One or more virtual machines can be installed on the virtualization system, and each virtual machine may have its own unique virtual machine ID. The Hypervisor 230 can determine a corresponding virtual machine and the operating system of the corresponding virtual machine running (such as a LINUX operating system, an ANDROID operating system or QNX operating system) on the corresponding virtual machine according to the virtual machine ID. After obtaining the read request from the semantic information reconstructing module 250, the read request is parsed to obtain information contained in the read request, such as the virtual machine ID, the operation type, and the virtual address of symbol.

At step S320, the Hypervisor accesses the memory area of the virtual machine to perform an operation of reading data according to the received read request, and returns the operation result. For example, the Hypervisor 230 may read data from the memory area of the VM and return the read data.

Specifically, when the operation type is determined to be a read/write operation according to the parsing result, the memory area of the VM in the Hypervisor 230 is accessed to perform an operation of reading data/writing data, and the processing result is returned. In other words, when it is determined to perform the read/write operation, the data detection module 237 in FIG. 2 accesses the memory area of the VM to perform the operation of reading data/writing data.

Specifically, the operation of reading data may be realized through the following operations: determining a corresponding VM (for example, the VM corresponding to the first operating system 1 of a VM in FIG. 2), according to the virtual machine ID included in the read request; determining the memory area of the VM to be accessed, according to the determined VM and the virtual address of the symbol included in the read request; and performing a read operation on the memory area of the VM, so as to obtain metadata. The metadata and the performing result (for example, read success or failure) may be returned as an operation result.

At Step S330, semantic information is reconstructed based on the operation result, on an apparatus located outside a virtualization system to which the Hypervisor belongs.

In an embodiment, the reconstructing of the semantic information based on the operation result, on a device located outside a virtualization system to which the Hypervisor belongs includes: parsing metadata contained in the operation result by using symbol table information and source code of an operating system of the VM; and reconstructing data structure and high-level semantic information of the operating system of the VM according to the parsed metadata. Through the semantic information reconstruction, the running state of the virtual machine can be obtained, so as to obtain a snapshot of the operating system of the VM at runtime. At least one embodiment of the present disclosure can reduce the burden on the Hypervisor 230 to a large extent by means of semantic reconstruction on an apparatus (such as PC end 260) outside the virtualization system. In this way, embodiments of the present disclosure can reduce the performance cost of the entire system.

Due to the above operations, at least one embodiment of the present disclosure does not need to make any modification or addition of any module in the operating system of the VM, and completely eliminates the performance overhead of the operating system of the VM caused by adding new modules. At least one embodiment of the present disclosure is configured to monitor a running state of a VM machine by adding only lightweight modules (for example, the VMI message processing module234, the data detection module 237, etc.) into the Hypervisor 230.

After the semantic information is reconstructed by the above Step S330, the method may further include: receiving a write request to access the memory area of the VM through the Hypervisor 230 for data writing, and the Hypervisor 230 accessing the memory area of the VM to perform an operation of writing data according to the write request. The write request may conform to data structure and high-level semantic information of the operating system of the VM obtained through the reconstructing semantic information.

Specifically, similar to the content with respect to the read request described in step S310, a virtual address corresponding to each symbol is obtained through a kernel symbol table information of an operating system of the VM, and then, according to the demand, a user inputs the write request to access the memory area of the VM through the Hypervisor 230 for data writing. That is, the write request can be received from an external apparatus 260. Then, the semantic information reconstructing module 250 transmits the write request to the VMI message processing module 234. In an embodiment, the write request not only includes a virtual machine ID, an operation type and a virtual address of the symbol, but also includes data to be written. For the write request, the operation type can indicate the write operation type. After obtaining the write request from the semantic information reconstructing module 250, the write request is parsed to obtain the above information contained in the write request.

The operation of writing data may include: determining a corresponding VM (for example, the VM corresponding to the first operating system 1 of a VM in FIG. 2), according to the virtual machine ID included in the write request; determining the memory area of the VM to be accessed, according to the determined VM and the virtual address of the symbol included in the write request; and performing a write operation on the memory area of the VM. An operation result (for example, write success or failure) may be further returned as result of performing the writing operation.

In the above process of performing the read/write operation according to the read/write request, when accessing the memory area of the VM, for example, the virtual address of the symbol can be converted into a physical address by using an address translation (AT) instruction, and the memory area of the VM to be accessed can be determined according to the physical address, or, the memory area of the virtual machine can be accessed directly by using the Virtualization Host Extension Features (VHE) without converting the virtual address to the physical address.

After the semantic information is reconstructed, the method may further include: receiving a program scheduling request for scheduling a virtual machine program in the operating system of the VM in the Hypervisor 230, and the Hypervisor 230 scheduling the virtual machine program to perform operations according to the program scheduling request. In an embodiment, the program scheduling request conforms to data structure and high-level semantic information of the operating system of the VM obtained through the reconstructing semantic information, and the program scheduling request is received from an external apparatus 260.

In an embodiment, when the program scheduling request is received, the OS routine execution module 238 in FIG. 2 schedules the virtual machine program to perform operations in the operating system of the VM in the Hypervisor 230 according to the program scheduling request. In an embodiment, the scheduling of the virtual machine program to perform operations, is executed in the Hypervisor 230 at an exception level 2 in case hardware of the virtualization system supports VHE. In an embodiment, the scheduling of the virtual machine program to perform operations includes: determining a corresponding VM, according to the virtual machine ID included in the program scheduling request; determining the virtual machine program in the operating system of the VM, according to the determined VM and the virtual address of the symbol included in the program scheduling request; and scheduling the virtual machine program to perform operations, in the Hypervisor 230.

Due to the above operations, an embodiment of the present disclosure in a virtualization system with hardware supporting VHE, by running a specified virtual machine program on the Hypervisor 230 side, changes the timing and order of the execution of the client virtual machine functions, so as to increase the operation efficiency of the system. The client virtual machine function may include an initialization function in the startup phase of the operating system of the VM,

In addition, embodiments of the present disclosure can be applied to Type-1 virtualization systems based on a system on chip (SOC), and can monitor and change the operation strategy of the operating system of the VM without the awareness of the operating system of the VM, so as to increase the system performance. In addition, embodiments of the present disclosure can also be used to collect information about the VM when the VM is in an abnormal state, and use the collected information to conduct an analysis to increase the maintainability of the system. For example, in various SOC based virtualization systems (including QNX operating system, LINUX operating system, ANDROID operating system, etc.), when the VM has an exception (for example, some high priority tasks occupy the CPU all the time, resulting in low priority tasks unable to obtain CPU scheduling), it is impossible to log in to the operating system through a serial port or other methods to obtain more information for further analysis. However, using an embodiment of the method of the present disclosure described above, all task information of the VM can be obtained by the Hypervisor 230 through the VMI, so that tasks that have been occupying the CPU and their call information can be obtained.

FIG. 4 is a block diagram illustrating a device 400 of implementing VMI according to an exemplary embodiment of the present disclosure.

Refer to FIG. 4, the device 400 may include a VMI message processing module 234, a data detection module and a semantic information reconstructing module 250.

The VMI message processing module 234 may be configured to receive a read request to access a memory area of a VM through the Hypervisor 230 for data reading.

The data detection module may be configured to access the memory area of the VM to perform an operation of reading data according to the read request in the Hypervisor 230, and return the operation result.

In an embodiment, the semantic information reconstructing module 250 is located on an apparatus 260 outside a virtualization system to which the Hypervisor 230 belongs to reconstruct semantic information based on the operation result. In an embodiment, the semantic information reconstructing module 250 reconstructs the semantic information by: parsing metadata contained in the operation result by using symbol table information and source code of an operating system of the VM; and reconstructing data structure and high-level semantic information of the operating system of the VM according to the parsed metadata.

According to an exemplary embodiment of the present disclosure, the VMI message processing module 234 is further configured to receive a write request to access the memory area of the VM through the Hypervisor 230 for data writing, and the data detection module is further configured to access the memory area of the VM to perform an operation of writing data according to the write request in the Hypervisor 230. In an embodiment, the VMI message processing module 234 is further configured to receive a program scheduling request for scheduling a virtual machine program in the operating system of the VM in the Hypervisor 230, and the device 400 further includes: an Operating System (OS) routine execution module configured to schedule the virtual machine program to perform operations according to the program scheduling request in the Hypervisor 230. In an embodiment, the write request and the program scheduling request conform to data structure and high-level semantic information of the operating system of the VM obtained through the reconstructing semantic information. The data detection module and OS routine execution module may be included in the data detection and routine execution module 236.

The VMI message processing module 234, the data detection module, the semantic information reconstructing module 250 and the OS routine execution module in FIG. 4 respectively represent the same modules as the VMI message processing module, the data detection module, the semantic information reconstructing module and the OS routine execution module shown in FIG. 2 above. The VMI message processing module 234, the data detection module and the OS routine execution module are arranged in the Hypervisor. In an embodiment, the semantic information reconstructing module 250 is arranged in an apparatus 260 outside the virtualization system, but embodiment of the present disclosure are not limited thereto. The semantic information reconstructing module 250 can alternately be arranged in the Hypervisor 230, may have little impact on its performance.

Since in the method described above with reference to FIGS. 2 and 3, the details involved in the specific operations performed by the VMI message processing module 234, the data detection module, the semantic information reconstructing module 250 and the OS routine execution module have been described, they will not be repeated here. Any relevant details involved in the operations performed by the above mentioned units can reference the corresponding descriptions of FIGS. 2 and 3 provided above.

In addition, it should be noted that although the device 400 is divided into units for performing corresponding processing respectively, it should be clear to those skilled in the art that the processing performed by the above units can also be performed without any specific unit division or no clear demarcation between the units in the device 400. In addition, the unit division of device 400 is not limited to the example of FIG. 4, for example, any other reasonable division method can be adopted. The present disclosure has no limitation on the unit or module division of device 400, as long as it can implement the method shown in FIG. 3. In addition, the device 400 may also include other units, such as storage units and the like.

It should also be understood that various units can be implemented as one or more electronic circuits, and that one or more of the various units described above can also be implemented as a single electronic circuit.

The device for implementing VMI according to the embodiments of the disclosure do not need to make any modification or addition of any module in the operating system of the VM, and thus, completely eliminates performance overhead of the operating system of the VM caused by adding new modules. A method and device according to an embodiment monitors a running state of the VM by adding only lightweight modules (for example, a VMI message processing module 234, a data detection and routine execution module 236 (that is, a data detection module and an OS routine execution module)) into the Hypervisor 230. In an embodiment, the method and device can also access and modify the specified running parameters of the operating system of the VM on the Hypervisor side (such as executing the running parameters through write operations and scheduling the tasks), so as to optimize the running strategy of the operating system. Furthermore, in a virtualization system with hardware supporting VHE, by running a specified virtual machine program on the Hypervisor side, the timing and order of the execution of the client virtual machine functions (such as an initialization function in the startup phase of the operating system of the VM) may be changed, so as to increase the operation efficiency of the system. In addition, a device implementing VMI according to the embodiments of the present disclosure can perform semantic reconstruction through a semantic information reconstructing module 250 located in the PC end 260 outside the virtualization system, which can greatly reduce the burden on the Hypervisor 230, and similarly, reduce the performance overhead on the entire system.

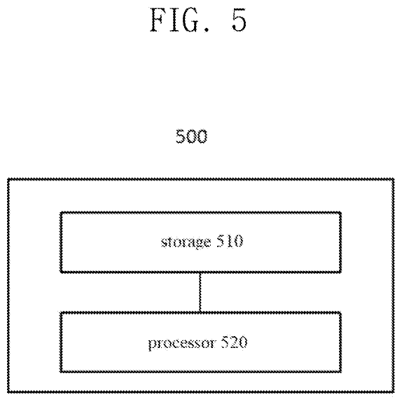

FIG. 5 is a block diagram of an electronic apparatus 500 according to an embodiment of the present disclosure.

Referring to FIG. 5, the electronic apparatus 500 may include at least one storage 510 (e.g., a memory device) and at least one processor 520. The at least one storage 510 stores computer-executable instructions, and the computer-executable instructions, when executed by the at least one processor 520, cause the at least one processor 520 to perform a method of implementing VMI according to embodiments of the present disclosure.

As an example, the electronic apparatus 500 may be a PC computer, a tablet device, a personal digital assistant, a smart phone, or other devices capable of executing the above set of instructions (for example, any electronic device that can be connected to a wireless LAN). Here, the electronic apparatus does not have to be a single electronic apparatus and may also be any device or a collection of circuits that may execute the above instructions (or instruction sets) individually or jointly. The electronic apparatus may also be a part of an integrated control system or a system manager, or may be configured as a portable electronic apparatus interconnected by an interface with a local or remote (e.g., via wireless transmission).

In the electronic apparatus, the processor 520 may include a central processing unit (CPU), a graphics processing unit (GPU), a programmable logic device, a dedicated processor system, a microcontroller, or a microprocessor. As an example and not limitation, the processor may also include an analog processor, a digital processor, a microprocessor, a multi-core processor, a processor array, a network processor, and the like.

The processor 520 may execute instructions or codes stored in the storage 510, where the storage 510 may also store data. Instructions and data may also be transmitted and received through a network via a network interface device, wherein the network interface device may use any known transmission protocol.

The storage 510 may be integrated with the processor 520 as a whole, for example, random-access memory (RAM) or a flash memory arranged in an integrated circuit microprocessor or the like. In addition, the storage 510 may include an independent device, such as an external disk drive, a storage array, or other storage device that may be used by any database system. The storage 510 and the processor 520 may be operatively coupled, or may communicate with each other, for example, through an input/output (I/O) port, a network connection, or the like, so that the processor 520 may read files stored in the storage 510.

In addition, the electronic apparatus may also include a video display (such as a liquid crystal display) and a user interaction interface (such as a keyboard, a mouse, a touch input device, etc.). All components of the electronic apparatus may be connected to each other via a bus and/or a network.

According to an embodiment of the present disclosure, there may also be provided a computer-readable storage medium storing instructions, wherein the instructions, when executed by at least one processor, cause the at least one processor to execute the method of implementing VMI according to the embodiment of the present disclosure. Examples of the computer-readable storage medium here include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, Hard Disk Drive (HDD), Solid State Drive (SSD), card storage (such as multimedia card, secure digital (SD) card or extremely fast digital (XD) card), magnetic tape, floppy disk, magneto-optical data storage device, optical data storage device, hard disk, solid state disk and any other devices which are configured to store computer programs and any associated data, data files, and data structures in a non-transitory manner, and provide the computer programs and any associated data, data files, and data structures to the processor or the computer, so that the processor or the computer may execute the computer programs. The instructions and the computer programs in the above computer-readable storage mediums may run in an environment deployed in computer equipment such as a client, a host, an agent device, a server, etc. In addition, in one example, the computer programs and any associated data, data files and data structures are distributed on networked computer systems, so that computer programs and any associated data, data files, and data structures are stored, accessed, and executed in a distributed manner through one or more processors or computers.

Those skilled in the art will understand that, without departing from the scope of the disclosure, embodiments of the disclosure can be modified according to the content already described. The present application is intended to cover any variations, uses, or adaptive changes of the present disclosure.

What is claimed is:

1. A method of implementing virtual machine introspection (VMI), comprises:
receiving, by a Hypervisor, a read request to access a memory area of a virtual machine for reading read data;
accessing, by the Hypervisor, the memory area of the virtual machine for performing an operation for reading the read data according to the read request to return an operation result; and
reconstructing, by an apparatus, semantic information based on the operation result,
wherein the apparatus is located outside a virtualization system including the Hypervisor.

2. The method according to claim 1, wherein the reconstructing of the semantic information comprises:
parsing metadata included in the operation result using symbol table information and source code of an operating system of the virtual machine to generate parsed metadata; and
reconstructing data structure and high-level semantic information of the operating system of the virtual machine according to the parsed metadata.

3. The method according to claim 1, wherein, after the semantic information is reconstructed, the method further comprises:
receiving a write request to access the memory area of the virtual machine through the Hypervisor for writing write data, and the Hypervisor accessing the memory area of the virtual machine to perform an operation of writing the write data according to the write request; and
receiving a program scheduling request for scheduling a virtual machine program in the operating system of the virtual machine in the Hypervisor, and the Hypervisor scheduling the virtual machine program to perform an operation according to the program scheduling request,
wherein, the write request and the program scheduling request conform to data structure and high-level semantic information of the operating system of the virtual machine obtained through the semantic information.

4. The method according to claim 3, wherein, each of the read request, the write request and the program scheduling request is received from the apparatus, and at least includes a virtual machine identifier (ID), an operation type, and a virtual address of a symbol.

5. The method according to claim 4, wherein, the operation of reading the read data comprises:
determining a corresponding virtual machine, according to the virtual machine ID included in the read request;
determining the memory area of the virtual machine to be accessed, according to the determined virtual machine and the virtual address of the symbol included in the read request; and
performing a read operation on the memory area of the virtual machine.

6. The method according to claim 4, wherein, the operation of writing the write data comprises:
determining a corresponding virtual machine, according to the virtual machine ID included in the write request;
determining the memory area of the virtual machine to be accessed, according to the determined virtual machine and the virtual address of the symbol included in the write request; and
performing a write operation on the memory area of the virtual machine.

7. The method according to claim 3, wherein, the scheduling of the virtual machine program to perform the operation is executed in the Hypervisor at an exception level 2 to support Virtualization Host Extension Features.

8. The method according to claim 4, wherein, the scheduling of the virtual machine program to perform the operation comprises:
determining a corresponding virtual machine, according to the virtual machine ID included in the program scheduling request;
determining the virtual machine program in the operating system of the virtual machine, according to the determined virtual machine and the virtual address of the symbol included in the program scheduling request; and
scheduling the virtual machine program to perform an operation, in the Hypervisor.

9. A device for implementing virtual machine introspection (VMI), comprises:
a VMI message processing module configured to receive a read request to access a memory area of a virtual machine through a Hypervisor for reading read data;
a data detection module configured to access the memory area of the virtual machine to perform an operation of reading the read data according to the read request in the Hypervisor to return an operation result; and
a semantic information reconstructing module configured to reconstruct semantic information based on the operation result,
wherein the semantic information reconstructing module is within an apparatus located outside a virtualization system that includes the Hypervisor.

10. The device of claim 9, wherein the semantic information reconstructing module recontructs the information by:
parsing metadata included in the operation result using symbol table information and source code of an operating system of the virtual machine to generate parsed metadata; and
reconstructing data structure and high-level semantic information of the operating system of the virtual machine according to the parsed metadata.

11. The device of claim 9, wherein the VMI message processing module is further configured to receive a write request to access the memory area of the virtual machine through the Hypervisor for writing write data, and the Hypervisor accesses the memory area of the virtual machine to perform an operation of writing the write data according to the write request.

12. The device of claim 11, wherein the VMI message processing module is further configured to receive a program scheduling request for scheduling a virtual machine program in the operating system of the virtual machine in the Hypervisor, and the Hypervisor schedules the virtual machine program to perform an operation according to the program scheduling request.

13. The device of claim 12, wherein, each of the read request, the write request and the program scheduling request is received from the apparatus, and at least includes a virtual machine identifier (ID), an operation type, and a virtual address of a symbol.

14. The device of claim 13, wherein the operation of reading the read data comprises:
determining a corresponding virtual machine, according to the virtual machine ID included in the read request;
determining the memory area of the virtual machine to be accessed, according to the determined virtual machine and the virtual address of the symbol included in the read request; and
performing a read operation on the memory area of the virtual machine.

15. The device of claim 13, wherein the operation of writing the write data comprises:
determining a corresponding virtual machine, according to the virtual machine ID included in the write request;
determining the memory area of the virtual machine to be accessed, according to the determined virtual machine and the virtual address of the symbol included in the write request; and
performing a write operation on the memory area of the virtual machine.

16. A computer program product for implementing virtual machine introspection (VMI), the computer program product being tangibly embodied on a non-transitory computer-readable storage medium and comprising instructions that, when executed by at least one computing device, are configured to cause the at least one computing device to:
receive a read request from a Hypervisor to access a memory area of a virtual machine for reading read data;
access the memory area of the virtual machine using the Hypevisor to perform an operation for reading the read data according to the read request to return an operation result; and
reconstruct semantic information by an apparatus based on the operation result,
wherein the apparatus is located outside a virtualization system including the Hypervisor.

17. The computer program product of claim 16, wherein the at least one computing device is configured to reconstruct the semantic information by:
parsing metadata included in the operation result using symbol table information and source code of an operating system of the virtual machine to generate parsed metadata; and
reconstructing data structure and high-level semantic information of the operating system of the virtual machine according to the parsed metadata.

18. The computer program product of claim 16, wherein the at least one computing device is further configured to:
receive a write request to access the memory area of the virtual machine through the Hypervisor for writing write data, and the Hypervisor accesses the memory area of the virtual machine to perform an operation of writing the write data according to the write request.

19. The computer program product of claim 18, wherein the at least one computing device is configured to:
receive a program scheduling request for scheduling a virtual machine program in the operating system of the virtual machine in the Hypervisor, and the Hypervisor schedules the virtual machine program to perform an operation according to the program scheduling request.

20. The computer program product of claim 19, wherein the write request and the program scheduling request conform to data structure and high-level semantic information of the operating system of the virtual machine obtained through the semantic information.
